(19) United States
(12) Patent Application Publication
(10) Pub. No.: US 2019/0373884 A1
(43) Pub. Date: Dec. 12, 2019

(54) HERBICIDAL MIXTURE CONCENTRATES

(71) Applicant: Dow Global Technologies LLC, Midland, MI (US)

(72) Inventors: Hua Ren, Shanghai (CN); Ling Zhong, Shanghai (CN); Wei Lu, Shanghai (CN); Jianhai Mu, Shanghai (CN)

(73) Assignee: Dow Global Technologies LLC, Midland, MI (US)

(21) Appl. No.: 16/489,160

(22) PCT Filed: Feb. 28, 2017
(86) PCT No.: PCT/CN2017/075099

§ 371 Date: Aug. 27, 2019

(51) Int. Cl. A01N 25/30; A01N 57/20; A01N 25/04; A01N 43/60

(52) U.S. Cl. CPC A01N 25/30; A01N 43/60; A01N 25/04; A01N 57/20

(57) ABSTRACT

The present disclosure provides for a herbicidal mixture concentrate having a stable formulation of 5 to 30 weight percent (wt. %) of an active water soluble herbicide; 1 to 20 wt. % of an alkyl polyglucoside; 5 to 40 wt. % of a phosphate ester hydrotrope or salt thereof; optionally up to 25 wt. % of an organic solvent; and water to bring the wt. % of the herbicidal mixture concentrate to 100 wt. %, where all wt. % are based on a total weight of the herbicidal mixture concentrate and wherein the herbicidal mixture concentrate is present in a continuous clear single phase at a temperature from 0° C. to 54° C.

### TECHNICAL FIELD

The present disclosure relates generally to herbicides and more particularly to herbicidal mixture concentrates.

### BACKGROUND

Herbicidal mixture concentrates are desirable for a variety of economic and environmental reasons. These include, among others, the reduction of shipping and handling costs. Herbicidal mixture concentrates typically contain two or more active ingredients that provide a wide variety of agricultural applications. For example, two or more herbicidal active ingredients may be combined in order to control a wider spectrum of weeds, or to utilize multiple modes of action, compared to the individual active ingredients alone. These active ingredients often include both water-insoluble and water soluble compounds, where the water-soluble compounds are formulated in water while the water-insoluble herbicides are formulated in an organic solvent. The two formulations are then mixed to form an emulsion. However, such formulations present numerous challenges as they need to contain as high of an active concentration of the active ingredients as possible while still having the ability to form a physically and chemically stabile emulsion.

Preparing a herbicidal mixture concentrate as an emulsion can help to ensure active formulation stability and to improve wetting properties and herbicidal efficacy. Preparing herbicidal mixture concentrates as emulsions, however, can be challenging owing to chemical and/or physical instability of the active ingredients. Examples of physical instability with these compositions include, for example, phase separation, crystallization, settling, sedimentation, gelling, and agglomeration. Such physical instabilities are a drawback of highly concentrated formulations, as the concentration of the various active ingredients is no longer uniform throughout the herbicidal mixture concentrate.

For example, water soluble salts of herbicides, e.g., glufosinate or salts thereof, when dissolved in water form high ionic strength solutions that when combined with organic solutions containing oil-soluble herbicides normally form oil-in-water emulsions. These pre-mix, concentrate compositions, however, can be difficult to stabilize due to the high ionic strength of the aqueous phase. To form the emulsion, nonionic surfactants and anionic surfactants combinations are typically used in the herbicidal mixture concentrates. The surfactants, however, often times fail to form stable emulsions given the high concentrations of electrolytes (e.g., alkali and/or alkaline complexing agents, salts, and the like) needed to maintain stability across a wide temperature range (e.g., from 0 degrees Centigrade (° C.) to 54° C.).

So, it remains a challenge to obtain a stable emulsion of a herbicidal mixture when the concentration of the water soluble active ingredients are at concentration levels sufficiently high to form herbicidal mixture concentrates.

### SUMMARY

The present disclosure provides for herbicidal mixture concentrates that provide for a stable formulation having a high concentrations of water soluble active ingredients (e.g., glufosinate or a salt thereof). The herbicidal mixture concentrate of the present disclosure is also stable, occurring in a substantially continuous, clear single phase at temperature in a range of 0° C. to 54° C.

The herbicidal mixture concentrate of the present disclosure includes a stable formulation of 5 to 30 weight percent (wt. %) of an active water soluble herbicide; 1 to 20 wt. % of an alkyl polyglucoside; 5 to 40 wt. % of a phosphate ester hydrotrope or salt thereof; optionally up to 25 wt. % of an organic solvent; and water to bring the wt. % of the herbicidal mixture concentrate to 100 wt. %, where all wt. % provided herein are based on a total weight of the herbicidal mixture concentrate and where the herbicidal mixture concentrate is present in a continuous clear single phase at a temperature from 0° C. to 54° C.

The active water soluble herbicide of the herbicidal mixture concentrate is glufosinate or a salt thereof. For the herbicidal mixture concentrate, the alkyl of the alkyl polyglucoside is a C₄ to C₁₆ alkyl group, and, where the polyglucoside of the alkyl polyglucoside has an average degree of polymerization ranging from 1 to 3. In a specific embodiment, the alkyl polyglucoside is a C₈-C₁₆ alkyl polyglucoside. The phosphate ester hydrotrope is an alkyl aryl alkoxy phosphate ester or a salt thereof. In a specific embodiment, the salt is a potassium salt of the alkyl aryl alkoxy phosphate ester. The organic solvent is selected from the group consisting of cyclohexanone, isophorone, methyl isobutyl ketone, diisobutyl ketone, γ-butyrolactone, butyl acetate, pentyl propionate, diethylene glycol monoethyl ether, glycol ether dipropylene glycol n-propyl ether, glycol ether tripropylene glycol n-butyl ether, 2-(2-ethoxyethoxy) ethanol, propylene glycol monomethyl ether, tetrahydrofurfuryl alcohol, iso-propanol, dichlorotoluene, terpene hydrocarbon, oxyalcohol esters, N-methyl-2-pyrrolidone, and mixtures thereof.

The herbicidal mixture concentrate can further include 0.1 to 8 wt. % of an anti-freezer. The anti-freezer is selected from the group consisting of propylene glycol, ethylene glycol, glycerin or mixtures thereof. The herbicidal mixture concentrate can further include 0.1 to 10 wt. % of an anionic surfactant. The anionic surfactant is selected from the group consisting of sodium dodecylsulfate, sodium dodecylbenzene sulfonate, sodium dodecylnaphthalene sulfate, abitic acid, alkyldiphenyloxide disulfonate, sodium dodecylbenzene sulfonate, and combinations thereof. In one embodiment, the anionic surfactant is a C₆ to C₂₀ alkyldiphenyloxide disulfonate. The herbicidal mixture concentrate can also include 1 to 10 wt. % of a nonionic surfactant. In one embodiment, the nonionic surfactant is an alcohol alkoxylate.

The herbicidal mixture concentrate can further include up to 5 wt. % of an active water-insoluble herbicide. The active water-insoluble herbicide is selected from the group consisting of an aryloxyphenoxypropionate, a cyclohexanedione, a diphenyl ether, a nitrophenyl ether or combinations thereof. Examples of aryloxyphenoxypropionate include quizalofop-p-ethyl, fenoxyaprop or fluazifop-p; examples of cyclohexanedione include clethodim or sethoxydim; examples of diphenyl ether or nitrophenyl ether include oxyfluorfen, acifluorfen, fomesafen and lacotfen.

### DETAILED DESCRIPTION

The present disclosure provides for herbicidal mixture concentrates that use alkyl polyglucoside surfactants and phosphate ester hydrotropes to achieve high concentrations of an active water soluble herbicide (e.g., glufosinate or a salt thereof) in a single phase formulation containing other water-insoluble active ingredients. As provided herein, the herbicidal mixture concentrate of the present disclosure is present in a continuous clear single phase emulsion at a temperature from 0° C. to 54° C.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein.

As used herein, the term “stable” refers to physically stable compositions; i.e., liquid compositions that exist in a substantially continuous, clear single phase.

As used herein, the term “organic solvents” refers to, for example, nonpolar solvents, polar protic solvents, aprotic polar solvents and mixtures thereof.

As used herein, the term “emulsion” refers to a fluid colloidal system in which liquid droplets and/or liquid crystals are dispersed in a liquid, where, as used herein, the emulsion of the present disclosure has the aqueous phase as the continuous phase.

All weight percent (wt. %) values provided herein are based on a total weight of the herbicidal mixture concentrate.

The herbicidal mixture concentrate of the present disclosure includes a stable formulation of 5 to 30 weight percent (wt. %) of an active water soluble herbicide; 1 to 20 wt. % of an alkyl polyglucoside; 5 to 40 wt. % of a phosphate ester hydrotrope or salt thereof; optionally up to 25 wt. % of an organic solvent; and water to bring the wt. % of the herbicidal mixture concentrate to 100 wt. %. The herbicidal mixture concentrate is present in a continuous clear single phase at a temperature from 0° C. to 54° C. As discussed herein, the herbicidal mixture concentrate of the present disclosure can include additional compounds. It is understood that the amount of water used to bring the wt. % of the herbicidal mixture concentrate to 100 wt. % takes into account these additional compounds.

The herbicidal mixture concentrate of the present disclosure can also include a stable formulation of 15 to 25 wt. % of an active water soluble herbicide; an active water-insoluble herbicide up to 4 wt. %; 2 to 9 wt. % of an anionic surfactant; 6 to 12 wt. % of an alkyl polyglucoside; 24 to 26 wt. % of a phosphate ester hydrotrope or salt thereof; optionally up to 15 wt. % of an organic solvent; and water to bring the wt. % of the herbicidal mixture concentrate to 100 wt. %. The herbicidal mixture concentrate is present in a continuous clear single phase at a temperature from 0° C. to 54° C.

The herbicidal mixture concentrate of the present disclosure can also include a stable formulation of 15 to 25 wt. % of an active water soluble herbicide; an active water-insoluble herbicide up to 4 wt. %; 1 to 20 wt. % of an alkyl polyglucoside; 6 to 25 wt. % of a phosphate ester hydrotrope or salt thereof; 1 to 12 wt. % of an organic solvent; and water to bring the wt. % of the herbicidal mixture concentrate to 100 wt. %. The herbicidal mixture concentrate is present in a continuous clear single phase at a temperature from 0° C. to 54° C.

The herbicidal mixture concentrate of the present disclosure can also include a stable formulation of 20 wt. % of an active water soluble herbicide; 2 wt. % of an active water-insoluble herbicide; 9 wt. % of an alkyl polyglucoside; 14.4 wt. % of a phosphate ester hydrotrope or salt thereof; 4.5 wt. % of an organic solvent; and water to bring the wt. % of the herbicidal mixture concentrate to 100 wt. %. The herbicidal mixture concentrate is present in a continuous clear single phase at a temperature from 0° C. to 54° C.

The herbicidal mixture concentrate of the present disclosure can also include a stable formulation of 20 wt. % of an active water soluble herbicide; 2 wt. % of an active water-insoluble herbicide; 1 wt. % of an anionic surfactant; 6 wt. % of an alkyl polyglucoside; 32.5 wt. % of a phosphate ester hydrotrope or salt thereof; 12 wt. % of an organic solvent; and water to bring the wt. % of the herbicidal mixture concentrate to 100 wt. %. The herbicidal mixture concentrate is present in a continuous clear single phase at a temperature from 0° C. to 54° C.

### Active Water Soluble Herbicide

The active water soluble herbicide of the herbicidal mixture concentrate can be present in an amount of 5 to 30 wt. %. Preferably, the active water soluble herbicide of the herbicidal mixture concentrate is present in an amount of 15 to 25 wt. %. More preferably, the active water soluble herbicide of the herbicidal mixture concentrate is present in an amount of 18 to 20 wt. %. Examples of the active water soluble herbicide include glufosinate and salts thereof. Glufosinate is the common name for (RS)-2-Amino-4-(hydroxy(methyl)phosphonoyl)butanoic acid. In addition to glufosinate and salts thereof, the active water soluble herbicide of the herbicidal mixture concentrate can be Glyphosate (the common name for N-(phosphonomethyl)glycine), paraquat (the common name for N,N′-dimethyl-4,4′-bipyridinium dichloride), diquat (the common name for 6,7-dihydrodipyrido[1,2-a:2′,1′-c]pyrazinediium dibromide) and the like. Mixtures may also be used.

Alkyl Polyglucoside

The herbicidal mixture concentrate further includes an alkyl polyglucoside (“APG”) surfactant. The herbicidal mixture concentrate includes 1 to 20 wt. % of the alkyl polyglucoside. In addition, the herbicidal mixture concentrate can include 6 to 12 wt. % of the alkyl polyglucoside.

Alkyl polyglucosides are formed from the reaction of glucose and fatty alcohol and have a hydrophobic portion (carbon chain) and a hydrophilic portion (glycoside unit or group) in the presence of an acid catalyst. The glycoside units of each alkyl group of the alkyl polyglucoside have an average degree of polymerization (DP) from about 1 to about 3. As appreciated, the DP indicates the average number of glucose units for each alkyl group, where the alkyl polyglucoside normally has a mixture of varying amounts of glucose units on the molecule.

The alkyl polyglucoside acts as an emulsifier and includes both a hydrophilic end and an alkyl group (varying lengths) that forms a hydrophobic end. Alkyl polyglucosides may be represented by the following general formula:

R²O(CₙH₂ₙO)ₜ(glucosyl)ₓ

wherein R² is selected from the group consisting of alkyl, alkylphenyl, hydroxyalkyl, hydroxyalkylphenyl, and mixtures thereof in which the alkyl group is a C₄ to C₁₆ alkyl group. More preferably, the alkyl group of the alkyl polyglucoside is a C₈ to C₁₆ alkyl group. In addition, n is about 2 or about 3, preferably about 2; t is from 0 to about 5, preferably 0 to 3; and x is from about 1 to about 3, preferably from about 1 to about 2, most preferably from about 1.2 to about 1.8. The glucosyl is preferably derived from glucose. To prepare these compounds, the alcohol or alkylpolyethoxy alcohol is formed first and then reacted with glucose, or a source of glucose, to form the glucoside (attachment at the 1-position). The additional glucosyl units can then be attached between their 1-position and the preceding glucosyl units 2-, 3-, 4- and/or 6-position, preferably predominantly the 2-position.

Specific examples of suitable alkyl polyglucosides include those available under the tradename Plantaren® from BASF SE. Additional suitable alkyl polyglucosides include, but are not limited to GLUCOPON® 225DK, in which the alkyl group contains 8 to 10 carbon atoms and has an average DP of 1.7; GLUCOPON® 625UP, in which the alkyl group has 12 to 16 carbon atoms and has an average DP of 1.6; APG® 325N, in which the alkyl group has 9 to 11 carbon atoms and has an average DP of 1.5; GLUCOPON® 600UP, in which the alkyl group has 12 to 16 carbon atoms and has an average DP of 1.4; PLANTAREN 2000®, in which the alkyl group has 8 to 16 carbon atoms and has an average DP of 1.5; and PLANTAREN 1300®, in which the alkyl group has 12 to 16 carbon atoms and an average DP of 1.6. Additional alkyl polyglucosides include, for example, APG 325® (a C₉-C₁₁ alkyl polyglucoside available from Cognis Corporation), APG 625® (a C₁₀-C₁₆ alkyl polyglucoside available from Cognis Corporation), Dow TRITON™ CG-50, Dow TRITON™ CG-110, Dow TRITON™ CG-600, Dow TRITON™ CG-650 (a series of C₈-C₁₆ alkyl polyglucosides available from The Dow Chemical Company), AG6202® (a C₈ alkyl polyglucoside available from Akzo Nobel) Glucopon® 425N (a C₈-C₁₆ alkyl polyglucoside available from Cognis Corporation), Glucopon® 215 (a C₈-C₁₀ alkyl polyglucoside available from Cognis Corporation), Glucpon® 225 (a C₈-C₁₀ alkyl polyglucoside available from Cognis Corporation) and Alkadet 15® (a C₈-C₁₀ alkyl polyglucoside available from Huntsman Corporation).

### Phosphate Ester Hydrotrope

The herbicidal mixture concentrate further includes a phosphate ester hydrotrope or salt thereof. The herbicidal mixture concentrate includes 5 to 40 wt. % of the phosphate ester hydrotrope or salt thereof. The herbicidal mixture concentrate can also include 6 to 25 wt. % of the phosphate ester hydrotrope or salt thereof. The herbicidal mixture concentrate can also include 24 to 26 wt. % of the phosphate ester hydrotrope or salt thereof.

For the various embodiments, the phosphate ester hydrotrope is an alkyl aryl alkoxy phosphate ester or a salt thereof, where the aryl and alkoxy portions of the molecule can be repeated numerous times and can be substituted or unsubstituted. In a specific embodiment, the salt is a potassium salt of the alkyl aryl alkoxy phosphate ester. Phosphate ester hydrotropes are anionic phosphate ester surfactants containing at least one phosphate ester moiety. As “hydrotropes”, such compounds help solubilize other surfactants, and may themselves have surfactant properties. A preferred phosphate ester hydrotrope is an alkyl aryl alkoxy phosphate, potassium salt that is commercially available as TRITON™ H-66 from The Dow Chemical Company. Other useful commercial products include TRITON™ H-55, TRITON™ QS-44, TRITON™ XQS-20, aryl alkoxy phosphate esters, or their potassium salt.

### Organic Solvent

The herbicidal mixture concentrate can further include an organic solvent. The herbicidal mixture concentrate can include optionally up to 25 wt. % of an organic solvent. The herbicidal mixture concentrate can also include optionally up to 15 wt. % of the organic solvent. The herbicidal mixture concentrate can also include 1 to 12 wt. % of the organic solvent.

For the various embodiments, suitable organic solvents include those that can dissolve water-insoluble herbicides, examples of which are provided herein. Examples of such organic solvents include those is selected from the group consisting of cyclohexanone, isophorone, methyl isobutyl ketone, diisobutyl ketone, y-butyrolactone, butyl acetate, pentyl propionate, diethylene glycol monoethyl ether, glycol ether dipropylene glycol n-propyl ether, glycol ether tripropylene glycol n-butyl ether, 2-(2-ethoxyethoxy) ethanol, propylene glycol monomethyl ether, tetrahydrofurfuryl alcohol, iso-propanol, dichlorotoluene, terpene hydrocarbon, oxyalcohol esters, N-Methyl-2-pyrrolidone, and mixtures thereof. One preferred organic solvent is diethylene glycol monoethyl ether, which is sold under the tradename CARBITOL™ by The Dow Chemical Company.

### Anti-Freezer

The herbicidal mixture concentrate can further optionally include an anti-freezer. When present, the herbicidal mixture concentrate preferably includes 0.1 to 8 wt. % of the anti-freezer. More preferably, the herbicidal mixture concentrate includes 2 to 6 wt. % of the anti-freezer. For the various embodiments, the anti-freezer can be selected from the group consisting of propylene glycol, ethylene glycol, glycerin or mixtures thereof.

### Anionic Surfactant

The herbicidal mixture concentrate can further optionally include an anionic surfactant. When present, the herbicidal mixture concentrate includes 0.1 to 10 wt. % of the anionic surfactant. In an additional embodiment, the herbicidal mixture concentrate includes 1 to 9 wt. % of the anionic surfactant. In another embodiment, the herbicidal mixture concentrate includes 2 to 9 wt. % of the anionic surfactant.

The anionic surfactant can be selected from the group consisting of sodium dodecylsulfate, sodium dodecylbenzene sulfonate, sodium dodecylnaphthalene sulfate, abitic acid, alkyldiphenyloxide disulfonate, sodium dodecylbenzene sulfonate, and combinations thereof. In one embodiment, the anionic surfactant is a C₆ to C₂₀ alkyldiphenyloxide disulfonate. Preferably, the anionic surfactant is DOWFAX™ 2A1, which is an alkyldiphenyloxide disulfonate available from The Dow Chemical Company. Combinations of these surfactants and any of the foregoing anionic surfactants may be utilized in embodiments.

### Nonionic Surfactant

The herbicidal mixture concentrate can further optionally include a nonionic surfactant. When present, the herbicidal mixture concentrate preferably includes 1 to 10 wt. % of the nonionic surfactant. Examples of nonionic surfactants suitable for use in the present disclosure include an alcohol alkoxylate. Examples include ethylene oxide condensate products of secondary aliphatic alcohols containing 8 to 18 carbon atoms in a straight or branched chain configuration condensed with 5 to 30 moles of ethylene oxide. Examples of commercially available nonionic surfactants of the foregoing type are C₁₂-C₁₄ secondary alkanol condensed with either 9 moles of ethylene oxide (TERGITOL™ 15-S-9—a secondary alcohol ethoxylate, nonionic surfactant) or 12 moles of ethylene oxide (TERGITOL™ 15-S-12) available from The Dow Chemical Company.

### Active Water-Insoluble Herbicide

The herbicidal mixture concentrate can further optionally include an active water-insoluble herbicide. When present, the herbicidal mixture concentrate preferably includes up to 5 wt. % of the active water-insoluble herbicide. Preferably, the herbicidal mixture concentrate preferably includes up to 4 wt. % of the active water-insoluble herbicide. The active water-insoluble herbicide can be selected from the group consisting of an aryloxyphenoxypropionate, a cyclohexanedione, a diphenyl ether, a nitrophenyl ether or combinations thereof. Examples of aryloxyphenoxypropionate include quizalofop-p-ethyl, ethyl 2-[4-[(6-chloro-2-benzoxazolyl)oxy]phenoxy] propanoate] (commonly known as fenoxyaprop), or (R)244[445[-(trifluoro-methyl)-2-pyridinyl]oxy]-phenoxy] propanoate (commonly known as fluazifop-p); examples of cyclohexanedione include (+/−) 2-{(E)-1-{3-chloroallyloxyimino]propyl] -5-{2-(ethylthio)propyl}-hydroxycyclohexen-2-one (commonly known as clethodim) or 2[1-(ethoxyimino)butyl]-5-[2-(ethylthio)propyl]-3-hydroxy-2-cyclohexen-1-one (commonly known as sethoxydim); examples of diphenyl ether or nitrophenyl ether include (2-chloro-1-(3-ethoxy-4-nitrophenoxy)-4-(trifluromethyl)benzene (commonly known as oxyfluorfen), sodium 5-[2-chloro-4-(trifluoro-methyl)phenoxy]-2-nitrobenzoate (commonly known as acifluorfen), 5-]2-chloro-4-(trifluoromethyl)phenoxy]-N-(methylsulfonyl)-2-nitrobenzamide (commonly known as fomesafen) and ethyl O{5-(2-chloro-a,a,a-trifluoro-p-toluoxy)-2-nitrobenzoyl}-DL-lactate (commonly known as lacotfen).

### Water

The herbicidal mixture concentrate further include water. As discussed herein, the herbicidal mixture concentrate includes water so as to bring the weight percent of the herbicidal mixture concentrate to 100 wt. %. As such, the weight percent of water used in the herbicidal mixture concentrate can vary depending upon the weight percent of the other components used in forming the herbicidal mixture concentrate. Typically, the water is present in an amount of 70 wt. % or less so as to bring the bring the weight percent of the herbicidal mixture concentrate to 100 wt. %. Preferably, deionized water is used.

### Emulsions

The herbicidal mixture concentrate of the present disclosure can be formed in a variety of ways. For example, the water soluble components of the herbicidal mixture concentrate can be mixed with the water at room temperature (23° C.) so as bring them into solution. Similarly, the water-insoluble components of the herbicidal mixture concentrate can be mixed with the organic solvent so as bring them into solution. The two solutions are then mixed using a mixing apparatus so as to form an emulsion. Mixing can occur at room temperature and at atmospheric pressure (101.3 kPa). Suitable mixing apparatus include vortex mixers, blenders, agitators, paddle mixers, emulsifiers and homogenizers, among others.

The composition of the present disclosure may optionally include auxiliary agents commonly used in herbicide formulations and known to those skilled in the art. Examples include wetting agents, dispersants, emulsifiers, penetrants, preservatives, antifreezes and evaporation inhibitors such as glycerol, sorbitol, sodium lactate, fillers, carriers, colorants including pigments and/or dyes, pH modifiers (buffers, acids, and bases), salts such as calcium, magnesium, ammonium, potassium, sodium, and/or iron chlorides, fertilizers such as ammonium sulfate and ammonium nitrate, urea, and defoamers. Suitable defoamers include all customary defoamers including silicone-based and those based upon perfluoroalkyl phosphinic and phosohonic acids, in particular silicone-based defoamers, such as silicone oils, for example.

### EXAMPLES

All reagents purchased from commercial vendors and used as received unless otherwise noted. All percentages are weight percentages (wt. %) based on the total weight of the herbicidal mixture concentrate, unless otherwise noted.

The reagents used for preparing herbicidal mixture concentrate Examples (Ex.) and Comparative Examples (CE) are listed in Table 1.

TABLE 1
Reagents and Commercial Sources

| Reagent | Source |
|---|---|
| Glufosinate (94 wt. %*) | HeBei Veyong Bio-Chemical Co., Ltd |
| (active water soluble | |
| herbicide) | |
| Quizalofop-p-ethyl (95 | HeBei Veyong Bio-Chemical Co., Ltd |
| wt. %*) (active water- | |
| insoluble herbicide) | |
| Clethodim (85 wt. %*) | Shandong Qiaochang Chemical Co., Ltd |
| (active water-insoluble | |
| herbicide) | |
| DOWFAX ™ 2A1 | The Dow Chemical Company |
| (anionic surfactant) | |
| TRITON ™ H-66 | The Dow Chemical Company |
| (phosphate ester | |
| hydrotrope) | |
| TRITON ™ CG-110 | The Dow Chemical Company |
| (alkyl polyglucoside) | |
| TRITON ™ CG-650 | The Dow Chemical Company |
| (alkyl polyglucoside) | |
| ECOSURF ™ EH-6 | The Dow Chemical Company |
| (nonionic surfactant) | |
| TERGITOL ™ 15-S-9 | The Dow Chemical Company |
| (secondary alcohol | |
| ethoxylate, nonionic | |
| surfactant) | |
| CARBITOL ™ Solvent | The Dow Chemical Company |
| (organic solvent) | |
| Propylene glycol | Sinopharm Chemical Reagent Co., Ltd. |
| (anti-freezer) | |
| Cyclohexanone | Sinopharm Chemical Reagent Co., Ltd |
| (organic solvent) | |

*weight percent is based on the total weight of the reagent as supplied.

Prepare the Examples and Comparative Examples of the herbicidal mixture concentrate at room temperature (23° C.). The reagents and their respective weight percent for each of the Examples and Comparative Examples are provided below in Tables 2, 4 and 5, below. Prepare the Examples and Comparative Examples by mixing and brining into solution the water soluble reagents, including water soluble herbicides, surfactants and hydrotropes with deionized water. Bring the water-insoluble reagents into solution with the organic solvent. Combine the mixture of the water soluble reagents and the mixture of the organic soluble reagents and mix for 30 minutes using a IKA KS501D votex mixer/shaker at speed of 300 rpm until an homogeneous emulsion is formed.

TABLE 2
Examples and Comparative Examples of Emulsions of the Herbicidal Mixture
Concentrate

| | | | | | Comparative | Comparative |
|---|---|---|---|---|---|---|
| | Example 1 | Example 2 | Example 3 | Example 4 | Example A | Example B |
| Glufosinate | 20 wt. % | 20 wt. % | 20 wt. % | 20 wt. % | 20 wt. % | 20 wt. % |
| (94 wt. %) | | | | | | |
| Quizalofop-p- | 2 wt. % | 2 wt. % | — | — | 2 wt. % | 2 wt. % |
| ethyl | | | | | | |
| (95 wt. %) | | | | | | |
| Clethodim | — | — | 2 wt. % | 2 wt. % | — | — |
| (85 wt. %) | | | | | | |
| DOWFAX ™ | 1 wt. % | 1 wt. % | — | — | 2 wt. % | 2 wt. % |
| 2A1 | | | | | | |
| ECOSURF ™ | — | — | — | — | 20 wt. % | 20 wt. % |
| EH-6 | | | | | | |
| TRITON ™ | 6 wt. % | — | 9 wt. % | — | — | — |
| CG-110 | | | | | | |
| TRITON ™ | — | 6 wt. % | — | 9 wt. % | — | — |
| CG-650 | | | | | | |
| TRITON ™ H- | 32.5 wt. % | 32.5 wt. % | 14.4 wt. % | 14.4 wt. % | 5 wt. % | 20 wt. % |
| 66 | | | | | | |
| Cyclohexanone | 12 wt. % | 12 wt. % | — | — | 15 wt. % | 15 wt. % |
| CARBITOL ™ | — | — | 4.5 wt. % | 4.5 wt. % | — | — |
| Solvent | | | | | | |
| DI Water | 26.5 wt. % | 26.5 wt. % | 50.1 wt. % | 50.1 wt. % | 36 wt. % | 21 wt. % |

*— weight percent is based on the total weight of the reagent as supplied.

### Performance Evaluation of the Examples and Comparative Examples

Clarity/Stability at Room Temperature (23° C.)

Evaluate the clarity and stability of the Examples and Comparative Examples by visual inspection for a clear single phase without phase separation or turbidity occurring after two weeks storage at room temperature (23° C.).

Clarity/Stability at 54° C.

Evaluate the clarity and the stability of the Examples and Comparative Examples by visual inspection for a clear single phase without phase separation or turbidity occurring after two weeks storage at 54° C.

Clarity/Stability at 0° C.

Evaluate the clarity and the stability of the Examples and Comparative Examples by visual inspection for a clear single phase without phase separation or turbidity occurring after two weeks storage at 0° C.

### Clarity/Stability Results

Table 3 provides the results of the clarity and the stability evaluation for the Examples and Comparative Examples.

TABLE 3
Evaluation Results of Clarity and Stability

| | Clarity/Stability | | |
|---|---|---|---|
| | at room | | |
| | temperature | Clarity/Stability | Clarity/Stability |
| | (23° C., after 2 | at 0° C. | at 54° C. |
| | weeks) | (after 2 weeks) | (after 2 weeks) |
| Ex 1 | Clear single | Clear single | Clear single |
| | phase, stable | phase, stable | phase, stable |
| Ex 2 | Clear single | Clear single | Clear single |
| | phase, stable | phase, stable | phase, stable |
| Ex 3 | Clear single | Clear single | Clear single |
| | phase, stable | phase, stable | phase, stable |
| Ex 4 | Clear single | Clear single | Clear single |
| | phase, stable | phase, stable | phase, stable |
| CE A | Turbid/phase | Turbid/phase | Turbid/phase |
| | separation | separation | separation |
| CE B | Turbid/phase | Turbid/phase | Turbid/phase |
| | separation | separation | separation |

The results seen in Table 3 demonstrate that traditional alcohol ethoxylate based emulsifiers (e.g., ECOSURF™ EH-6) and their combinations with nonionic or ionic surfactants fail to form stable, clear and single phase formulations. In contrast, the Examples of the present disclosure that include both the alkyl polyglucoside and the phosphate ester hydrotrope exhibit a synergetic performance in forming stable emulsion formulation at high electrolyte conditions (e.g., 20 wt. % of glufosinate), which is superior to traditional nonionic/anionic surfactants combinations.

The following provides further illustrations of the highly specific nature of the herbicidal mixture concentrate formulations need to prepare a stability formulation. The following Examples and Comparative Examples are each prepared as described above. The Examples and Comparative Examples seen in Table 4 include 20 wt. % of the glufosinate, 2 wt. % of quizalofop-p-ethyl; 39.5 wt. % of a ternary combination (TERGITOL 15-S-9, TRITON™ CG-650 and TRITON™ H-66) and 38.5 wt. % water. The Examples and Comparative Examples seen in Table 5 include 20 wt. % of the glufosinate, 2 wt. % of Clethodim; 27.9 wt. % of a ternary combination (CARBITOL™ Solvent, TRITON™ CG-110 and TRITON™ H-66) and 50.1 wt. % water. As seen in Table 4, the ternary combination of the examples includes TRITON™ CG-650, TRITON™ H-66 and TERGITOL™ 15-S-9, where Table 4 provides the wt. % values for each of the TRITON™ CG-650, TRITON™ H-66 and TERGITOL™ 15-S-9. As seen in Table 5, the ternary combination of the examples includes TRITON™ CG-110, TRITON™ H-66 and CARBITOL™ Solvent, where Table 5 provides the wt. % values for each of the TRITON™ CG-110, TRITON™ H-66 and CARBITOL™ Solvent.

For Tables 4 and 5, the stability of the each of the Examples and Comparative Examples is tested as described above for the clarity/stability at the temperature indicated in the Table (e.g., 0° C., 23° C. or 54° C.), where the evaluation of clarity and the stability by visual inspection for a clear single phase without phase separation or turbidity occurring after two weeks storage. Tables 4 and 5 provide a value for the stability of each example, where a value of 0 indicates no phase separation was seen. The value between 0 to 1 indicates the level of instability/phase separation of the formulation, the larger value means greater phase separation and poor stability, value 1 means very obvious phase separation occurred (usually the smaller phase volume ratio between 0.25 to 0.5). The values between 0 and 1 indicate the relative percentage of separation that occurred in the example.

TABLE 4
Stability of Examples with ternary combination of TRITON ™ CG-650,
TRITON ™ H-66 and TERGITOL ™ 15-S-9 at 23° C. and 54° C. after Two Weeks of Storage

| | | Quizalofop- | | TRITON ™ | TRITON ™ | Phase | Phase |
|---|---|---|---|---|---|---|---|
| | Glufosinate | p-ethyl (95 wt. | TERGITOL ™ | CG-650 | H-66 | Sep. | Sep. |
| | (94 wt. %*) | %*) | 15-S-9 (wt %) | (wt %) | (wt %) | at 23° C. | at 54° C. |
| CE C | 20 wt. % | 2 wt. % | 2.60 | 25.91 | 10.99 | 1 | 0.3 |
| CE D | 20 wt. % | 2 wt. % | 13.29 | 14.70 | 11.51 | 1 | 0.4 |
| CE E | 20 wt. % | 2 wt. % | 6.74 | 26.42 | 6.34 | 1 | 0.3 |
| CE F | 20 wt. % | 2 wt. % | 13.71 | 20.15 | 5.63 | 1 | 0.4 |
| CE G | 20 wt. % | 2 wt. % | 2.31 | 7.93 | 29.25 | 1 | 0 |
| CE H | 20 wt. % | 2 wt. % | 7.70 | 2.69 | 29.11 | 0 | 1 |
| CE I | 20 wt. % | 2 wt. % | 13.00 | 10.11 | 16.39 | 1 | 0.5 |
| CE J | 20 wt. % | 2 wt. % | 19.23 | 7.19 | 13.09 | 1 | 0.5 |
| Ex 5 | 20 wt. % | 2 wt. % | 2.89 | 11.49 | 25.12 | 0 | 0 |
| CE K | 20 wt. % | 2 wt. % | 20.18 | 17.26 | 2.05 | 1 | 0.4 |
| CE L | 20 wt. % | 2 wt. % | 14.52 | 3.14 | 21.85 | 1 | 0.7 |
| CE M | 20 wt. % | 2 wt. % | 25.32 | 10.80 | 3.37 | 1 | 0.5 |
| CE N | 20 wt. % | 2 wt. % | 26.13 | 4.46 | 8.90 | 1 | 0.5 |
| CE O | 20 wt. % | 2 wt. % | 9.04 | 20.27 | 10.19 | 1 | 0.4 |
| CE P | 20 wt. % | 2 wt. % | 14.59 | 23.36 | 1.55 | 1 | 0.3 |
| Ex 6 | 20 wt. % | 2 wt. % | 8.39 | 6.18 | 24.93 | 0 | 0 |
| CE Q | 20 wt. % | 2 wt. % | 8.08 | 11.55 | 19.86 | 1 | 0.7 |
| CE R | 20 wt. % | 2 wt. % | 3.06 | 16.09 | 20.35 | 0 | 0.7 |
| CE S | 20 wt. % | 2 wt. % | 4.13 | 19.30 | 16.07 | 1 | 0.4 |
| CE T | 20 wt. % | 2 wt. % | 10.03 | 27.19 | 2.28 | 1 | 0.3 |
| CE U | 20 wt. % | 2 wt. % | 32.75 | 3.26 | 3.49 | 1 | 0.5 |
| CE V | 20 wt. % | 2 wt. % | 3.10 | 33.14 | 3.26 | 1 | 0.3 |
| CE W | 20 wt. % | 2 wt. % | 19.09 | 12.48 | 7.93 | 1 | 0.4 |
| CE X | 20 wt. % | 2 wt. % | 20.76 | 2.45 | 16.29 | 1 | 0.5 |

*weight percent is based on the total weight of the reagent as supplied.

As seen above, only two examples (Examples 5 and 6) passed both the room temperature (23° C.) and the 54° C. stability test, whereas all the other examples (Comparative Examples C through X) failed.

The Examples seen below in Table 5 provide data from tests conducted at 0° C., 23° C. and 54° C. further indicate that increasing the dosage of the TRITON™ H-66 and replacing TRITON™ CG-650 and TERGITOL™ 15-S-9 with TRITON™ CG-110 and CARBITOL™ Solvent, respectively, can help to further improve the low temperature performance of the herbicidal mixture concentrate.

TABLE 5
Stability of Examples with ternary combination of TRITON ™ CG-110,
TRITON ™ H-66 and CARBITOL ™ Solvent at 0° C. and 54° C. after Two Weeks of Storage

| | | | | TRITON ™ | | | | | |
|---|---|---|---|---|---|---|---|---|---|
| | | | CARBITOL ™ | CG- | TRITON ™ | Phase | Phase | Phase | |
| | Glufosinate | Clethodim | Solvent | 110 | H-66 | Sep. | Sep. | Sep. at | Total |
| | (94 wt. %*) | (85 wt. %*) | (wt %) | (wt %) | (wt %) | at 23° C. | at 0° C. | 54° C. | Stability |
| Ex 7 | 20 wt. % | 2 wt. % | 2.86 | 10.12 | 14.92 | 0 | 0 | 0 | 0 |
| Ex 8 | 20 wt. % | 2 wt. % | 11.75 | 4.61 | 11.54 | 0 | 0 | 0 | 0 |
| CE Y | 20 wt. % | 2 wt. % | 4.59 | 21.45 | 1.87 | 1 | 1 | 0.3 | 2.3 |
| Ex 9 | 20 wt. % | 2 wt. % | 5.13 | 1.81 | 20.95 | 0 | 0 | 0 | 0 |
| CE Z | 20 wt. % | 2 wt. % | 10.52 | 1.97 | 15.42 | 1 | 0 | 1 | 2 |
| CE AA | 20 wt. % | 2 wt. % | 4.32 | 14.23 | 9.35 | 0 | 0 | 1 | 1 |
| CE AB | 20 wt. % | 2 wt. % | 1.49 | 24.23 | 2.18 | 1 | 1 | 0 | 2 |
| Ex 10 | 20 wt. % | 2 wt. % | 5.11 | 4.92 | 17.87 | 0 | 0 | 0 | 0 |
| CE AC | 20 wt. % | 2 wt. % | 7.56 | 12.18 | 8.16 | 1 | 1 | 0.5 | 2.5 |
| CE AD | 20 wt. % | 2 wt. % | 7.13 | 6.83 | 13.95 | 0 | 0 | 0.5 | 0.5 |
| Ex 11 | 20 wt. % | 2 wt. % | 1.23 | 14.64 | 12.02 | 0 | 0 | 0 | 0 |
| CE AE | 20 wt. % | 2 wt. % | 11.45 | 13.85 | 2.60 | 0 | 0 | 0.5 | 0.5 |
| CE AF | 20 wt. % | 2 wt. % | 12.80 | 9.12 | 5.98 | 0 | 0 | 0.5 | 0.5 |
| Ex 12 | 20 wt. % | 2 wt. % | 1.34 | 6.18 | 20.38 | 0 | 0 | 0 | 0 |
| CE AG | 20 wt. % | 2 wt. % | 9.61 | 8.35 | 9.94 | 1 | 1 | 0.5 | 2.5 |
| CE AH | 20 wt. % | 2 wt. % | 17.01 | 1.07 | 9.82 | 1 | 1 | 0.6 | 2.6 |
| CE AI | 20 wt. % | 2 wt. % | 20.09 | 2.19 | 5.62 | 1 | 1 | 0.6 | 2.6 |
| CE AJ | 20 wt. % | 2 wt. % | 21.23 | 4.94 | 1.73 | 1 | 1 | 0.6 | 2.6 |
| CE AK | 20 wt. % | 2 wt. % | 15.47 | 4.30 | 8.13 | 1 | 1 | 0.6 | 2.6 |
| CE AL | 20 wt. % | 2 wt. % | 24.32 | 1.34 | 2.24 | 1 | 1 | 0.6 | 2.6 |
| CE AM | 20 wt. % | 2 wt. % | 17.21 | 7.67 | 3.01 | 1 | 1 | 0.4 | 2.4 |
| CE AN | 20 wt. % | 2 wt. % | 7.51 | 17.86 | 2.52 | 1 | 1 | 0.5 | 2.5 |
| Ex 13 | 20 wt. % | 2 wt. % | 2.13 | 18.89 | 6.88 | 0 | 0 | 0 | 0 |
| Ex 14 | 20 wt. % | 2 wt. % | 1.39 | 2.02 | 24.50 | 0 | 0 | 0 | 0 |

*weight percent is based on the total weight of the reagent as supplied.

Total Stability means stability at all three temperatures, 0 means no phase separation.

1. A herbicidal mixture concentrate, comprising:
a stable formulation of:
5 to 30 weight percent (wt. %) of an active water soluble herbicide;
1 to 20 wt. % of an alkyl polyglucoside;
5 to 40 wt. % of a phosphate ester hydrotrope or salt thereof;
optionally up to 25 wt. % of an organic solvent; and
water to bring the wt. % of the herbicidal mixture concentrate to 100 wt. %, where all wt. % are based on a total weight of the herbicidal mixture concentrate and wherein the herbicidal mixture concentrate is present in a continuous clear single phase at a temperature from 0° C. to 54° C.

2. The herbicidal mixture concentrate of claim 1, further including up to 5 wt. % of an active water-insoluble herbicide.

3. The herbicidal mixture concentrate of claim 2, wherein the active water-insoluble herbicide is selected from the group consisting of an aryloxyphenoxypropionate, a cyclohexanedione, a diphenyl ether, a nitrophenyl ether or combinations thereof.

4. The herbicidal mixture concentrate of claim 1, wherein the alkyl of the alkyl polyglucoside is a C₄ to C₁₆ alkyl group, and, wherein the polyglucoside of the alkyl polyglucoside has an average degree of polymerization ranging from 1 to 3.

5. The herbicidal mixture concentrate of claim 1, wherein the alkyl polyglucoside is a Cs-Cm alkyl polyglucoside.

6. The herbicidal mixture concentrate of claim 1, wherein the phosphate ester hydrotrope is an alkyl aryl alkoxy phosphate ester or a salt thereof.

7. The herbicidal mixture concentrate of claim 6, wherein the salt is a potassium salt of the alkyl aryl alkoxy phosphate ester.

8. The herbicidal mixture concentrate of claim 1, wherein the active water soluble herbicide is glufosinate or a salt thereof.

9. The herbicidal mixture concentrate of claim 1, wherein the organic solvent is selected from the group consisting of cyclohexanone, isophorone, methyl isobutyl ketone, diisobutyl ketone, y-butyrolactone, butyl acetate, pentyl propionate, diethylene glycol monoethyl ether, glycol ether dipropylene glycol n-propyl ether, glycol ether tripropylene glycol n-butyl ether, 2-(2-ethoxyethoxy) ethanol, propylene glycol monomethyl ether, tetrahydrofurfuryl alcohol, iso-propanol, dichlorotoluene, terpene hydrocarbon, oxyalcohol esters, N-Methyl-2-pyrrolidone, and mixtures thereof.

10. The herbicidal mixture concentrate of claim 1, further including 0.1 to 8 wt. % of an anti-freezer.

11. The herbicidal mixture concentrate of claim 10, wherein the anti-freezer is selected from the group consisting of propylene glycol, ethylene glycol, glycerin or mixtures thereof.

12. The herbicidal mixture concentrate of claim 1, wherein the herbicidal mixture concentrate includes 0.1 to 10 wt. % of an anionic surfactant.

13. The herbicidal mixture concentrate of claim 12, wherein the anionic surfactant is selected from the group consisting of sodium dodecylsulfate, sodium dodecylbenzene sulfonate, sodium dodecylnaphthalene sulfate, abitic acid, alkyldiphenyloxide disulfonate, sodium dodecylbenzene sulfonate, and combinations thereof.

14. The herbicidal mixture concentrate of claim 12, wherein the anionic surfactant is a C₆ to C₂₀ alkyldiphenyloxide disulfonate.

15. The herbicidal mixture concentrate of claim 1, wherein the herbicidal mixture concentrate includes 1 to 10 wt. % of a nonionic surfactant.

16. The herbicidal mixture concentrate of claim 15, wherein the nonionic surfactant is an alcohol alkoxylate
